(19) United States
(12) Patent Application Publication
(10) Pub. No.: US 2009/0094845 A1
(43) Pub. Date: Apr. 16, 2009

(54) METHOD AND DEVICE FOR THE MEASURING OF ANGLES OF WHEELS AND AXLES

(76) Inventor: Jonas Samuelsson, Orebro (SE)

Correspondence Address: HAYES SOLOWAY P.C., 3450 E. SUNRISE DRIVE, SUITE 140, TUCSON, AZ, 85718, US

(21) Appl. No.: 12/249,811

(22) Filed: Oct. 10, 2008

(30) Foreign Application Priority Data
Oct. 11, 2007 (SE) 0702284-1

(51) Int. Cl. G01B 11/26

(52) U.S. Cl. 33/288

(57) ABSTRACT

Method and device for the measuring of angles of axles at which on the axle or wheel in question that is to be measured are arranged two with a camera registrable markers (2, 4), which markers are arranged eccentrically in relation to the rotation axis of the axle and axially separated in the axle direction. The axle is rotated and the rotation paths of the markers or parts thereof are registered by the camera and used to calculate angle position or centre line of the axle. The device can be used to measure wheel angles of cars, at which no compensation for skew wheels is needed.

### BACKGROUND OF THE INVENTION

The present invention concerns methods and devices for the measuring angles and parallelism for axles, for instance wheel angles of vehicles or axle parallelism in machines.

More specifically the object of the invention is to eliminate the time consuming adjustment of markers on axles or wheels so that these markers or the like coincide with the axis of rotation in question. In the case of vehicle wheels the influence of skewness of the wheels and associated adjustment work is eliminated.

### SUMMARY OF THE INVENTION

In accordance with the invention the above object is solved by on the axle or wheel in question that is to be measured one or several with instrument registrable markers are arranged, which marker or markers are arranged eccentrically in relation to the rotation axle of the shaft. The shalt is rotated and the rotation path of the marker or the markers and parts thereof are registered and used to calculate angle position or centre line of the shaft.

A greater precision and simplicity is achieved with two by an instrument observable markers each a distance out from the centre and with different axial location. At the rotation of the shaft the markers will follow circles, the centres of which being on the extension of the rotational axis of an axle or a wheel. The distance between the centres of the path of the markers in the measured plane and the axial distance between the markers provide the angle, for instance with an iterative process as in the case with one marker.

Preferably the perspective of the registration device relative the circle is taken in account. To facilitate this the distance between circle and recording instrument is measured.

In the case of measurement of wheel angles on cars with two markers can be noted that a possible skewness of the wheel or a marker carrier on the wheel is of no influence. With knowledge of the axial distance between the markers a camera facing the car toe-in or toe-out can be calculated as the distance between the centre of the two circles in a horizontal direction divided with the distance axially between the markers.

The camber angle is obtained from the distance vertically between the centres of the circles divided with the axial distance between the markers.

The measures must be normed by consideration taken to the distance and perspective of the camera to the markers. This can be achieved by a tape ruler or by placing a further marker on the marker bracket in the same plane as for instance the one closest to the wheel. The camera can by triangulation measure the distance between camera and markers.

### BRIEF DESCRIPTION OF THE DRAWINGS

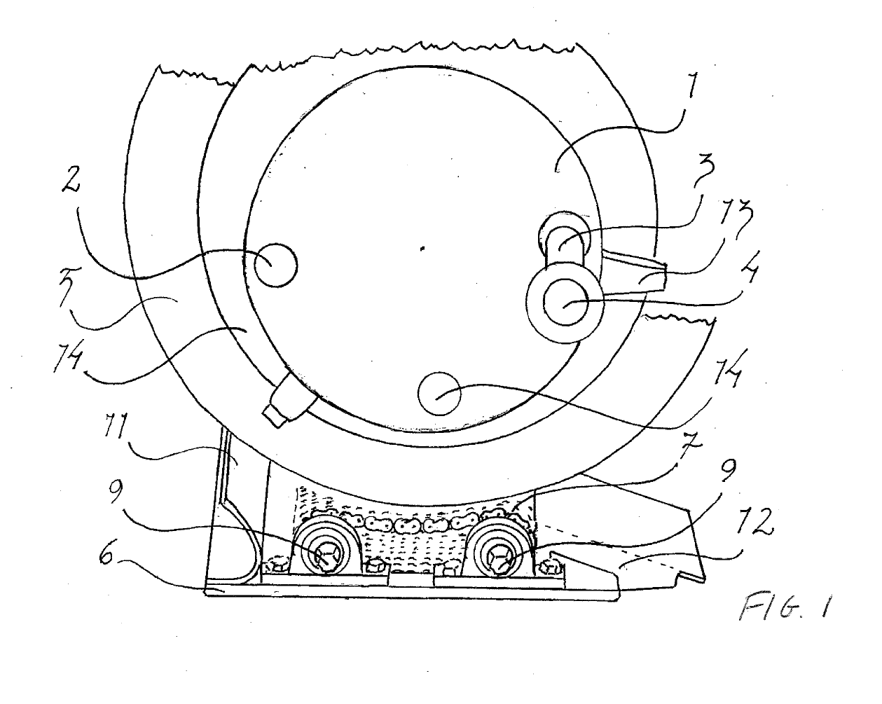

Further advantages and characteristics of the invention are apparent from the following description of a preferred embodiment referring to the enclosed drawing wherein FIG. 1 is a side elevational view illustrating a measuring device in accordance with the present invention.

### DETAILED DESCRIPTION

The embodiment shown in the drawing of a device in accordance of the invention includes a marker carrier provided with markers and intended for mounting on the outer side of the wheels, two cameras that at use are placed on each side of the vehicle and facing the wheels, a computer connected to the cameras, and two belt conveyors on which the wheels of the car are placed.

The marker carriers include brackets 13 that are clamped fast or snapped on to the outer side of the wheel rim 14. Further the marker carrier comprise an outward facing round disc 1 essentially parallel with the rim, On this disk a circular marker 2 of light or reflecting material is eccentrically arranged while the disk in its self is black. On the disk an eccentrically fastened pin 3 is further fastened, extending out from the disk away from the rim and perpendicular out from the disk. In the outer end of the pin a further circular marker 4 is arranged, also this light or reflecting. The two cameras facing the wheels and thus also the markers are of conventional type arranged in particular to register the positions of the markers and feed this information to the computer.

The belt conveyor devices on which the wheel of the car are rolled up include each two parallel shafts 9 on which chain sprockets have been arranged and over each pair of chain sprockets a chain 7 runs so that the chains together constitute a slightly downwards bulging bed supporting the wheels. The axles 9 are journaled in bearings, the bearing houses of which being mounted on a flat body 6. Seen in the roll on direction of the wheel a small ramp 12 is arranged in front of the chains allowing the wheel to roll up and on the other side of the chains 7 in the roll on direction an upward protruding stop 11 is arranged preventing the wheel from rolling over. The axles 9 are provided with key grips in their ends and can consequently be driven by for instance a nut driver. In order to prevent the wheel from climbing off on one side or the other due to deviation between a running direction of the wheel and the longitudinal direction of the chains at the rolling of the wheel on the chains, the chain supporting body 6 is advantageously journaled pivotable allowing the chains to adjust their direction according to that of the wheel when this is rotated.

At the above described device a measuring process may be as follows. The cameras and the belt conveyors are located in line with each other with the cameras in the outer ends and the belt conveyors in between. The cameras are connected to the computer and activated as the computer. Before the car with a wheel pair is driven up on the belt conveyors the cameras are aligned. This may of course be done by means of suitable sighting means alternatively one can use the pictures shown on screen of the computer and generated by the cameras of the opposite camera. One can also imagine that the aligning of the cameras, in addition to a rough manual aligning is obtained by the computer adapting the coordinate systems of each camera, that is to be used for measuring, to the centre to the other camera, for which the cameras may for instance be provided with a marker ring at the ocular of each camera.

When the cameras has been aligned the car may be driven up on the belt conveyors with one pair of wheels, for which one wish to measure the wheel angles and then in particular toe-in and camber. Initially the distance from each camera to the marker provided disks on each wheel is measured. For the sake of security the wheel pair that is not on the belt conveyors is blocked or braked.

One or both wheels that are on the belt conveyors are rotated. When a wheel is rotated the camera registers for each marker a ring shaped path. The marker on the disc and the one on the axially protruding pin are preferably different in a suitable way for identification in the computer. The registered ring-shaped marker paths are actually mostly ellipses but look almost circular. The ring shaped paths are centred around the extension of the rotation axis of the wheel. With knowledge of the distance between the markers axially the computer can calculate toe-in and camber-angle as described above. Instead of measuring the distance from the marker disc to the camera with a tape ruler one can imagine to arrange an additional marker 14 on the marker disk using the computer to calculate the distance by means of triangulation before the rotation begins.

Instead of, as has been described above, setting up the used components as loose parts one can imagine these rigidly mounted in floor and wall respectively, alternatively that rigid mounting means are arranged in the floor and that belt conveyors and cameras are mounted when measuring is to take place.

Even if the car at the placing on the belt conveyors do not end up with its longitudinal line of symmetry precisely perpendicular to the connection line between the cameras the toe-in measure will be sufficiently exact if the misalignment is moderate. The reason is that the variation in toe-in is very small in a relatively wide area around the wheel direction for driving straight forward. By not only measuring the mutual location of the marker rings but also for instance the location of the marker rings closest to the wheel in relation to the adjusted zero positions of the cameras the computer can caution if the car is too misaligned.

For the measuring of the camber-angle the above mentioned oblique position is not important, possibly if the car is extremely unevenly loaded or the ground is very inclined. This can be monitored in the same way as for toe-in.

For the identification of the markers these may have different gray scales or different colours or even be placed in such a way that mistakes are impossible, for instance the marker on the disc and closest to the wheel may have a smaller radius so that it will always be the inner one.

At the calculation of the centres of the ring shaped marker paths the inner, as well as the outer edge can be used as well as many points on each “ellipse”, since the formula is simple.

Within the frame of the inventive thought one can also imagine the cameras being mounted in a jig that is mounted on a car and that this rolls on the ground at measuring.

Instead of using cameras as measuring instruments and of these detectable markers one can use other versions of instruments and markers. For instance one can use a technique similar to that used for levelling instruments where the instrument emit a laser beam that by special reflectors is reflected back to the instrument that scans the marker area and registers directions were reflexes are obtained.

1-9. (canceled)

10. A method for the measuring of angles or parallelism for axles, wherein on each axle or wheel that is to be measured are two markers arranged axially separated and eccentrically in relation to the rotational axis of the axle or wheel, the axle or the wheel is rotated and the paths or points of these paths for the markers are registered using a registration instrument starting from which rotational centres of the markers are calculated and related to axial differences between the markers for the calculation of axle or wheel angles.

11. The method according to claim 10, wherein the instrument is a camera and that for each marker are registered height and lateral coordinates of the path centre, that is perpendicular to the view direction of the camera and vertically as well as horizontally, the difference between the coordinates related to the distance between the axial markers is then used to obtain the angles, in the case with a wheel camber and toe-in respectively.

12. The method according to claim 10, wherein starting from the distance and perspective between a marker and used instruments the angle calculations are corrected with consideration to this.

13. The method according to claim 11, wherein the distance between the instruments and one or both markers is measured using a camera to triangulate, and an additional marker on the same distance from the instrument as one of the markers for measuring angles.

14. The method according to claim 10, wherein two opposed cameras are arranged, facing each other and aligned for measuring of two sides at the same time.

15. The method according to claim 10, wherein a computer is used for the calculation.

16. The method according to claim 10, including the step of placing the wheels to be measured on belt conveyers, and rotating the wheels while they are being measured.

17. The method according to claim 10, wherein the axles comprise vehicle or machine axles.

18. A measuring device for the execution of the method according to claim 10, which comprises a registration instrument facing a side face the wheel or the axle end, and a marker carrier on the wheel or axle with two eccentric and axially separated placed markers on the side facing the registration instrument.

19. A measuring device according to claim 18, which includes belt conveyors for the wheels, which belt conveyors are pivotable on vertical axles so that they adjust to the running direction of the wheels, preventing the wheels from climbing off the conveyers laterally when they are rotated.

20. A measuring device according to claim 18, wherein the registration instrument comprises a camera.
